(19) United States
(12) Patent Application Publication
(10) Pub. No.: US 2025/0032910 A1
(43) Pub. Date: Jan. 30, 2025

(54) GRAPHICS PROCESSING TELEMETRY PIPELINE

(71) Applicant: Netflix, Inc., Los Gatos, CA (US)

(72) Inventor: Gregoire Pean, San Francisco, CA (US)

(21) Appl. No.: 18/357,926

(22) Filed: Jul. 24, 2023

(51) Int. Cl. A63F 13/355; A63F 13/352

(52) U.S. Cl. CPC A63F 13/355; A63F 13/352

(57) ABSTRACT

The disclosed computer-implemented method includes accessing telemetry events generated by one or more hardware components of a graphics processing unit (GPU) as part of a graphics generation process, serializing the accessed telemetry events into one or more specified data structures, storing the specified data structures associated with the serialized events in a shared memory location that is shared by multiple concurrently running media application sessions, and providing, in real time, a reference to the stored data structures associated with the serialized events in the shared memory location to specified event consumers. Various other methods, systems, and computer-readable media are also disclosed.

### BACKGROUND

In cloud gaming scenarios, video game data (including graphics) are largely rendered on remote servers and then transmitted to gaming clients where those data are decoded and displayed on an electronic device. When processing this video game data, graphics processing units (GPUs) typically implement multiple different hardware and software components. These hardware and software components each process different parts of a video game session and, during that process, each of these components generates observable metrics. These observable metrics (e.g., render time, encode time, GPU energy usage, session lifecycle events, etc.) are referred to as telemetry data. This telemetry data, however, is typically not transferred in real time and is not guaranteed to arrive. As such, telemetry messages may arrive slowly or may be dropped, leading to high latency and low reliability. Moreover, the large number of hardware and software components generating telemetry data often leads to disorganization and lost information among the many sources of telemetry data.

### SUMMARY

As will be described in greater detail below, the present disclosure describes methods and systems for efficiently transferring telemetry messages during a graphics generation process. In one embodiment, a computer-implemented method may be provided that includes: accessing telemetry events generated by hardware components of a graphics processing unit (GPU) as part of a graphics generation process. The method further includes serializing the accessed telemetry events into specified data structures, storing the specified data structures associated with the serialized events in a shared memory location that is shared by multiple concurrently running media application sessions, and providing, in real time, a reference to the stored data structures associated with the serialized events in the shared memory location to various event consumers.

In some embodiments, the concurrently running media sessions are video game sessions. In some cases, at least one of the event consumers is a video game operating system. In some examples, the telemetry events include video game session information including user information, client device information, quality of service (QOS) information, or video game session information.

In some cases, the above-described method further includes monitoring the references provided in real time to the shared memory location to initialize various processes related to the media sessions. In some embodiments, the initialized processes include a process to transition one or more media sessions to an alternate host computing system. In some examples, the initialized process includes a process to determine whether malicious activity is occurring on at least one of the media sessions.

In some embodiments, the method further includes aggregating multiple events from different media application sessions and routing the aggregated events to at least one of the event consumers. In some examples, the reference to the stored data structures associated with the serialized events is specified in a protocol buffer. In some cases, multiple references to stored data structures associated with the serialized events are co-located in an event pool in the shared memory location.

In some examples, the method further includes monitoring the event pool for changes in at least one of the events. Still further, in some examples, the method further includes tracking which serialized events are dropped during communication.

In addition, a corresponding system includes at least one physical processor, and physical memory comprising computer-executable instructions that, when executed by the physical processor, cause the physical processor to: access one or more telemetry events generated by one or more hardware components of a GPU as part of a graphics generation process, serialize the accessed telemetry events into one or more specified data structures, store the specified data structures associated with the serialized events in a shared memory location that is shared by a plurality of concurrently running media application sessions, and provide, in real time, a reference to the stored data structures associated with the serialized events in the shared memory location to one or more event consumers.

In some embodiments, the reference to the stored data structures associated with the serialized events in the shared memory location is provided to event consumers in batches. In some cases, the physical processor further adds various portions of contextual information to at least one of the batches provided to event consumers. One example of contextual information includes identifiers and data about a given gaming session, identifiers and information about the data collecting process (e.g., process name or persistent identifier (PID)), or freeform contextual information specified in the telemetry configuration process. In some examples, batching characteristics associated with the batches are configurable to define the batches in a customizable manner.

In some cases, the physical processor trains a machine learning model to perform at least one of: projecting communication metrics, planning GPU capacity, or projecting GPU usage. In some embodiments, the physical processor monitors the references provided in real time to the shared memory location to initialize various processes related to the media sessions. In some cases, the initialized processes include a process to determine whether malicious activity is occurring on at least one of the media sessions.

In some examples, the above-described method is encoded as computer-readable instructions on a computer-readable medium. For example, the computer-readable medium may include one or more computer-executable instructions that, when executed by at least one processor of a computing device, cause the computing device to: access telemetry events generated by one hardware components of a GPU as part of a graphics generation process, serialize the accessed telemetry events into specified data structures, store the specified data structures associated with the serialized events in a shared memory location that is shared by a plurality of concurrently running media application sessions, and provide, in real time, a reference to the stored data structures associated with the serialized events in the shared memory location to various event consumers.

Features from any of the embodiments described herein may be used in combination with one another in accordance with the general principles described herein. These and other embodiments, features, and advantages will be more fully understood upon reading the following detailed description in conjunction with the accompanying drawings and claims.

### BRIEF DESCRIPTION OF THE DRAWINGS

The accompanying drawings illustrate a number of exemplary embodiments and are a part of the specification. Together with the following description, these drawings demonstrate and explain various principles of the present disclosure.

FIG. 1 illustrates a computing environment in which the embodiments herein are designed to operate.

FIG. 2 is a flow diagram of an exemplary method for efficiently transferring telemetry messages during a graphics generation process.

FIG. 3 illustrates an alternative computing environment in which telemetry messages are aggregated and distributed.

FIGS. 4A and 4B illustrate a computing environment in which telemetry messages are transferred during a graphics generation process.

FIG. 5A illustrates a computing environment in which a computing environment is implemented to transfer telemetry messages among application instances.

FIG. 5B illustrates an alternative computing environment that provides a user interface that allows frame-based live performance monitoring of application instances.

FIG. 6 is a block diagram of an exemplary content distribution ecosystem.

FIG. 7 is a block diagram of an exemplary distribution infrastructure within the content distribution ecosystem shown in FIG. 6.

FIG. 8 is a block diagram of an exemplary content player within the content distribution ecosystem shown in FIG. 6.

Throughout the drawings, identical reference characters and descriptions indicate similar, but not necessarily identical, elements. While the exemplary embodiments described herein are susceptible to various modifications and alternative forms, specific embodiments have been shown by way of example in the drawings and will be described in detail herein. However, the exemplary embodiments described herein are not intended to be limited to the particular forms disclosed. Rather, the present disclosure covers all modifications, equivalents, and alternatives falling within the scope of the appended claims.

### DETAILED DESCRIPTION OF EXEMPLARY EMBODIMENTS

The present disclosure is generally directed to methods and systems for efficiently transferring telemetry messages during a graphics generation process. As noted above, applications such as video games are often hosted remotely on cloud computing systems. These cloud computing systems are capable of running many tens of thousands of concurrent gaming instances (or more). In some cases, many hundreds or thousands of different graphics processing units (GPUs) are implemented in parallel to host these different video game sessions. Each of these GPUs, in turn, may each include multiple hardware components of their own, including rendering modules and encoding modules. The rendering modules render images based on instructions from video game engines, and the encoding modules encode the rendered images to a specific resolution and/or frame rate for display on a monitor or electronic device.

When running these different video game instances, the various hardware and software modules of the GPU communicate with each other to indicate which operations they are performing, the number of items in their associated processing queues, the health of their memory, processors, or other hardware components, which video games (or other applications) they are running, which processes have been completed, which processes are ongoing, or other types of information. This information is typically passed along between components using telemetry messages. Because of the scale of cloud computing, the number of telemetry messages transferred between hardware and/or software GPU components can become very large. And, as such, in traditional systems, excessive amounts of processing time and resources can be expended simply managing the generation and transmission of telemetry messages within a graphics processing architecture.

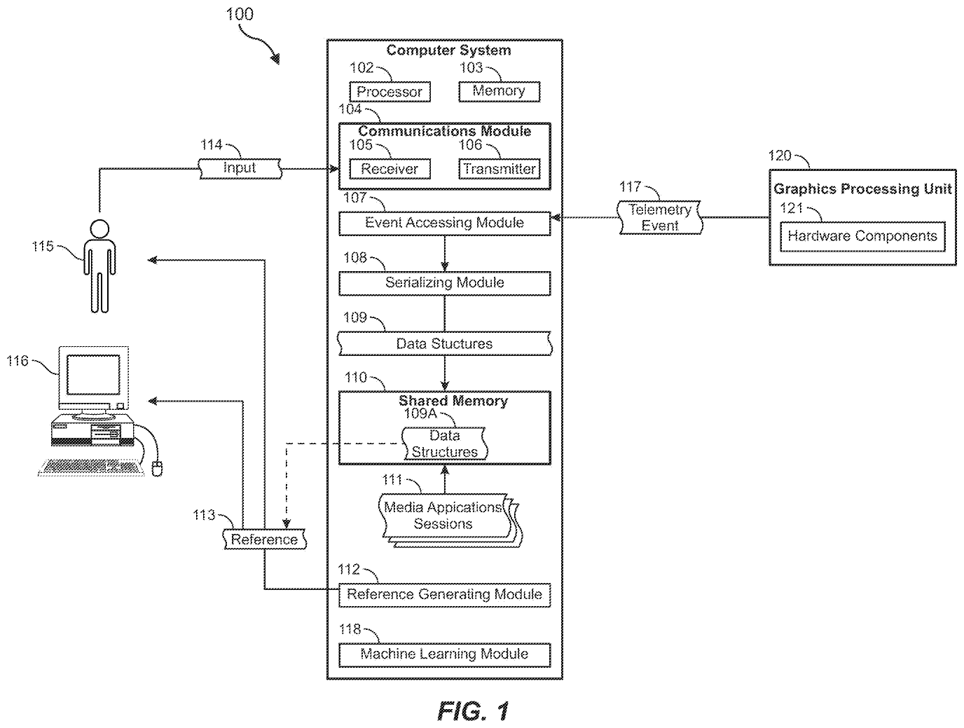

In contrast to such traditional systems, the embodiments herein are configured to process telemetry messages in a manner that is easier to send, easier to store, and easier to access. The systems herein store the telemetry messages in a shared (hardware) memory location that is shared by multiple concurrently running video game sessions. These systems then provide a reference to the telemetry messages stored in the shared memory location. The systems also change the format or serialization of the messages into a format that is easier to store and access. Because the messages are stored in a quickly accessible format, the embodiments herein greatly reduce the amount of time and computing resources spent on disseminating telemetry messages among GPUs and video game instances. These embodiments will be described in greater detail below with regard to FIGS. 1-8.

FIG. 1 illustrates a computing environment 100 that includes a computer system 101. The computer system 101 includes software modules, embedded hardware components such as processors, or includes a combination of hardware and software. The computer system 101 includes substantially any type of computing system including a local computing system or a distributed (e.g., cloud) computing system. In some cases, the computer system 101 includes at least one processor 102 and at least some system memory 103. The computer system 101 includes program modules for performing a variety of different functions. The program modules are hardware-based, software-based, or include a combination of hardware and software. Each program module uses computing hardware and/or software to perform specified functions, including those described herein below.

The computer system 101 includes a communications module 104 that is configured to communicate with other computer systems. The communications module 104 includes any wired or wireless communication means that can receive and/or transmit data to or from other computer systems. These communication means include hardware interfaces including Ethernet adapters, WIFI adapters, hardware radios including, for example, a hardware-based receiver 105, a hardware-based transmitter 106, or a combined hardware-based transceiver capable of both receiving and transmitting data. The radios are cellular radios, Bluetooth radios, global positioning system (GPS) radios, or other types of radios. The communications module 104 is configured to interact with databases, mobile computing devices (such as mobile phones or tablets), embedded or other types of computing systems.

The computer system 101 also includes an event accessing module 107. The accessing module 107 is configured to receive telemetry events 117 from a graphics processing unit (GPU). The GPU 120 includes multiple hardware components 121, along with other firmware and software components used in the generation of graphics for video games or for other media applications (e.g., videos, web pages, interactive content, etc.). As used herein, the terms “telemetry event” or “telemetry message” refer to information regarding an event that occurred during the generation of graphics for a media application. The telemetry event may refer to substantially any event for any video game session and may be transmitted from the GPU 120 to the processor 102 or between hardware components 121 of the GPU. Although shown as being separate components, it will be recognized that the GPU 120 may be part of computer system 101 or may be separate from computer system 101. Moreover, the GPU 120 may represent a single GPU or substantially any number of GPUs in a cloud computing architecture.

After the event accessing module 107 accesses one or more telemetry events 117, the serializing module 108 serializes the telemetry events into specific data structures 109. The term “serializing,” as used herein, refers to formatting, reformatting, or otherwise optimizing the structure of the telemetry event message into a specific format. That format may be optimized for storage and for quick access by other media application sessions or by other CPU hardware or software components. The serialized data structures 109 are stored in a shared memory 110. The shared memory 110 may include volatile and/or non-volatile memory and may be located in computer system 101 or in other computer systems (e.g., in the cloud). The shared memory 110 is shared with multiple different media application sessions 111 and/or with multiple GPUs 120 and their associated components. As such, each media application session 111 and each GPU 120 has direct access to the shared memory 110 and direct access to the shared data structures 109A.

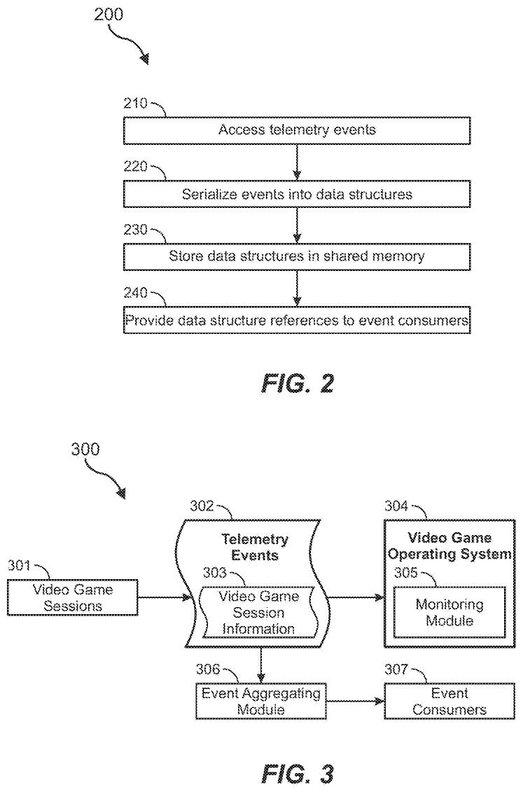

The reference generating module 112 of computer system 101 then generates a reference 113 to the stored data structures 109A and provides that reference 113 to various event consumers (e.g., computer system 116, user 115, or other applications, hardware modules, or entities). By providing the reference (as opposed to the telemetry message) to the stored data structure 109A in shared memory 110, the embodiments herein transmit fewer messages, transmit less data overall, and facilitate communication between media application sessions and/or between GPU components or between GPUs in a much more efficient manner. These embodiments will be explained further below with regard to method 200 of FIG. 2.

FIG. 2 is a flow diagram of an exemplary computer-implemented method 200 for efficiently transferring telemetry messages during a graphics generation process. The steps shown in FIG. 2 may be performed by any suitable computer-executable code and/or computing system, including the system illustrated in FIG. 1. In one example, each of the steps shown in FIG. 2 may represent an algorithm whose structure includes and/or is represented by multiple sub-steps, examples of which will be provided in greater detail below.

As illustrated in FIG. 2, a computer-implemented method 200 is provided. The method includes, at step 210, accessing telemetry events 117 generated by various hardware components 121 of a graphics processing unit (GPU) 120 as part of a graphics generation process. At step 220, the method 200 includes serializing the accessed telemetry events 117 into one or more specified data structures 109. The method 200 also includes, at step 230, storing the specified data structures 109 associated with the serialized events in a shared memory location 110 that is shared by multiple concurrently running media application sessions 111. Still further, the method 200 includes, at step 240, providing, in real time, a reference to the stored data structures 109A associated with the serialized events in the shared memory location 110 to specified event consumers (e.g., 115, 116, or other).

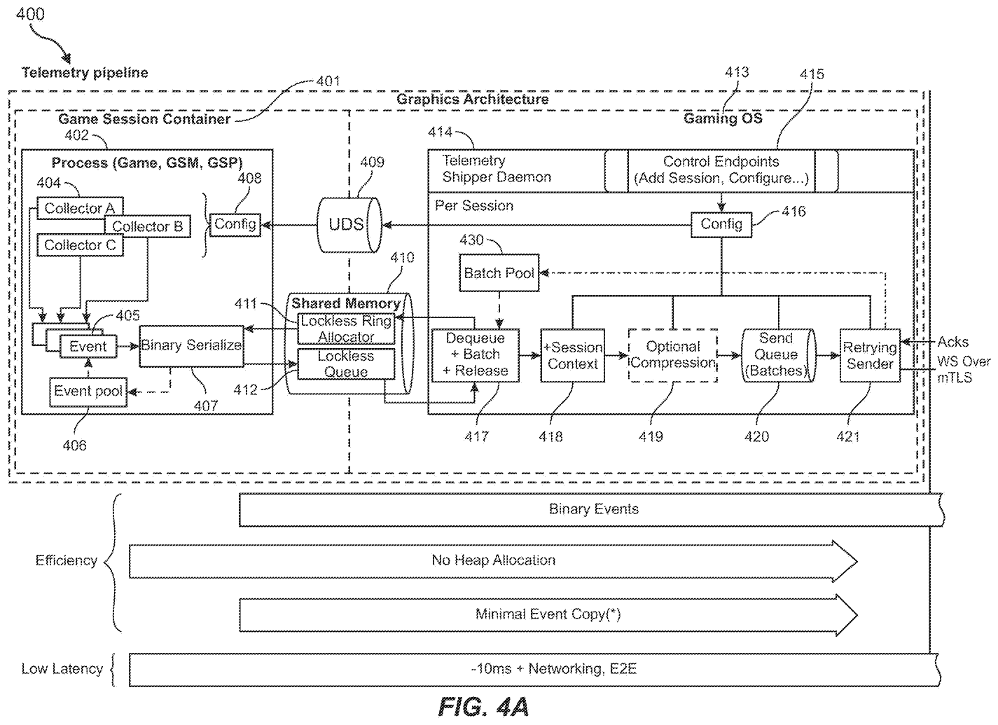

In some embodiments, as generally shown in embodiment 300 of FIG. 3, the concurrently running media sessions 111 of FIG. 1 may be video game sessions 301. The video game sessions 301 generate telemetry events 302 during operation. These telemetry events 302 are sent to various event consumers including, for example, a video game operating system 304. Thus, in such cases, the telemetry events 302 generated as part of the video game session 301 are received by video game operating system 304. The video game operating system 304 is configured to receive inputs from users, receive telemetry events and other game information, and then monitor and/or control the processing of the video game. The telemetry events 302 include video game session information 303 including user information, client device information, quality of service (QOS) information, or other types of video game session information.

The video game operating system 304 includes a monitoring module 305 to monitor the telemetry event references (e.g., 113 of FIG. 1) provided in real time to the shared memory location 110 to initialize various processes related to the video game sessions 301. For instance, in some cases, the monitoring module 305 monitors the telemetry events 302 that are sent to the video game operating system 304 and analyzes the video game session information 303 generated by the various video game sessions 301 (or other media sessions, such as streaming video sessions). The video game session information is analyzed to determine which actions to take relative to the telemetry events 302. In some cases, taking action includes initializing specified processes, some or all of which may be run or monitored by the video game operating system 304. In other cases, taking action includes terminating offending sessions in case those sessions have unacceptable or unplanned or unfair behavior with respect to GPU or CPU utilization.

In some embodiments, one of the initialized processes includes a process to transition video game sessions (e.g., 301) to an alternate host computer system. Accordingly, if the video game sessions are being hosted by one computer system (e.g., 101 of FIG. 1) and that computer system becomes unhealthy or is overloaded or needs software or hardware updates, one or more of the video game sessions 301 may be transitioned to another computer system or group of computer systems.

Additionally or alternatively, in some cases the initialized processes include determining whether malicious activity is occurring on the video game session 301. In such embodiments, malicious activity includes actions, whether manual or automatic, intended to cause harm to the video game sessions or to the underlying computer systems or to cause the video game sessions to malfunction or operate improperly. If the video game operating system 304 determines that malicious activity has occurred or is occurring, the video game operating system will take actions to mitigate the malicious activity, including blocking internet protocol (IP) addresses, booting users, powering down video game sessions, or taking other remedial actions.

In some embodiments, the reference 113 to the stored data structures 109A associated with the serialized events is specified in a protocol buffer. Thus, when computer systems or virtual operating systems are communicating with each other using different protocols, the embodiments herein will add the reference 113 to the stored data structures to a buffer in the protocol. This buffer refers to a location where reference data is stored and transported between computer systems according to the established protocol. In such cases, the protocol itself need not be changed; rather, the reference information can be added to a protocol buffer and transmitted along with other information (e.g., data structures 109A).

In some cases, the event aggregating module 306 of FIG. 3 is configured to aggregate events from different media application sessions 301 and route the aggregated events to various event consumers 307. The event consumers could be software applications, hardware or firmware modules, physical users, or other entities. The event aggregating module 306 is configured to aggregate substantially any number of telemetry events 302 and then disseminate those events in batches. Thus, in conjunction with FIG. 1, at least in some cases, the references to stored data structures 109A associated with serialized events stored in the shared memory location 110 are aggregated and provided to event consumers 307 in batches. These batches may include substantially any number of references.

In some examples, the event aggregating module 306 adds various portions of contextual information to the batches provided to event consumers 307. This contextual information indicates information about the batch including the size, the number of events, the type(s) of events, which video game sessions generated the events, etc. In some cases, batching characteristics associated with the batches are used to define the batches in a customizable manner. Thus, users (e.g., user 115 via input 114) or the video game operating system 304 can define custom batches with specific types of information or specific types of messages about the video game sessions. In this manner, each event consumer 307 may receive aggregations of those types of video game session events that they are interested in and avoid receiving other telemetry events 302 in which they may not be interested. Each event consumer 307 can define which telemetry events 302 they want to see and define the size or other characteristics of the batches they receive.

In some embodiments, multiple different references to stored data structures associated with the serialized events are co-located in an event pool or a batch pool in the shared memory location. At least in some examples, each of the stored data structures in the event pool are related to the same video game session (e.g., 301). In other cases, an event pool may include stored data structures from multiple different video game sessions. In some cases, the event pool includes data structures for certain types of video game sessions or for video game sessions of a specific video game.

In some examples, the monitoring module 305 of the video game operating system 304 is configured to monitor the event pool for changes in at least one of the events. For example, changes in the events may indicate that a server is not working properly, or may indicate that malicious activity is occurring, or may indicate that a server is overloaded or is running low on memory. In other cases, some of the serialized events may be dropped during communication. In such cases, the monitoring module 305 will track the serialized events to determine which events reached the appropriate event consumers 307 and which did not. Accordingly, the monitoring module 305 is configured to monitor the pooled events to identify dropped events or changes in event data or in event type and, when such occur, will notify the event consumers 307 of the changes.

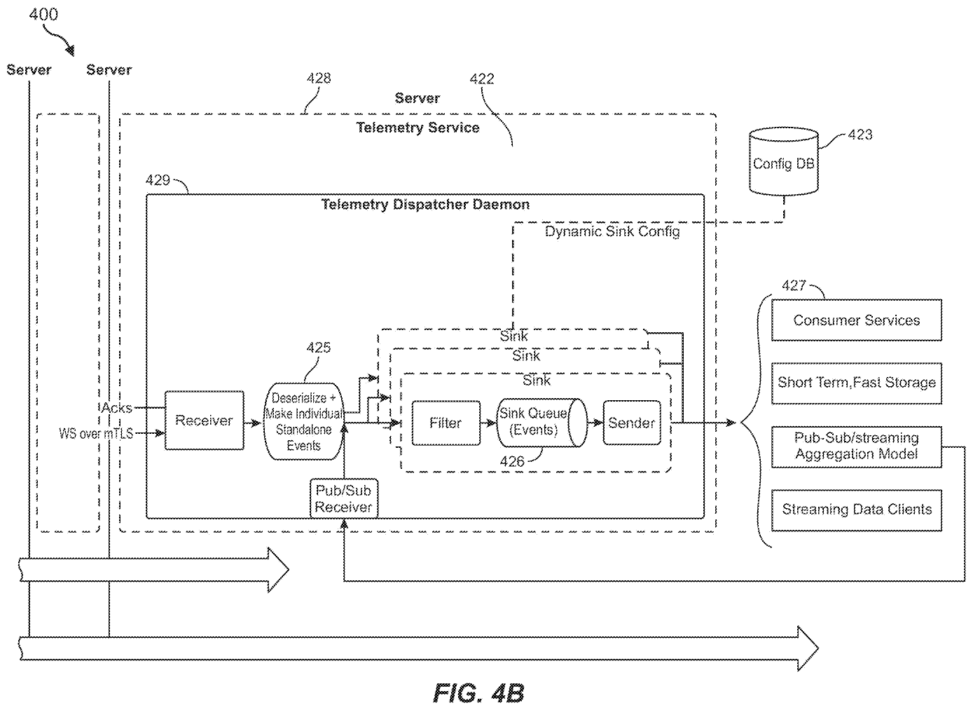

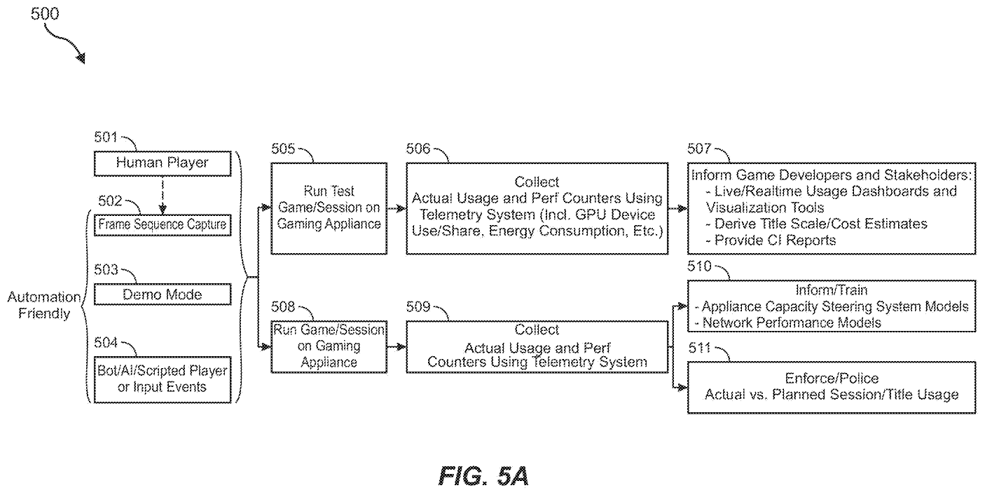

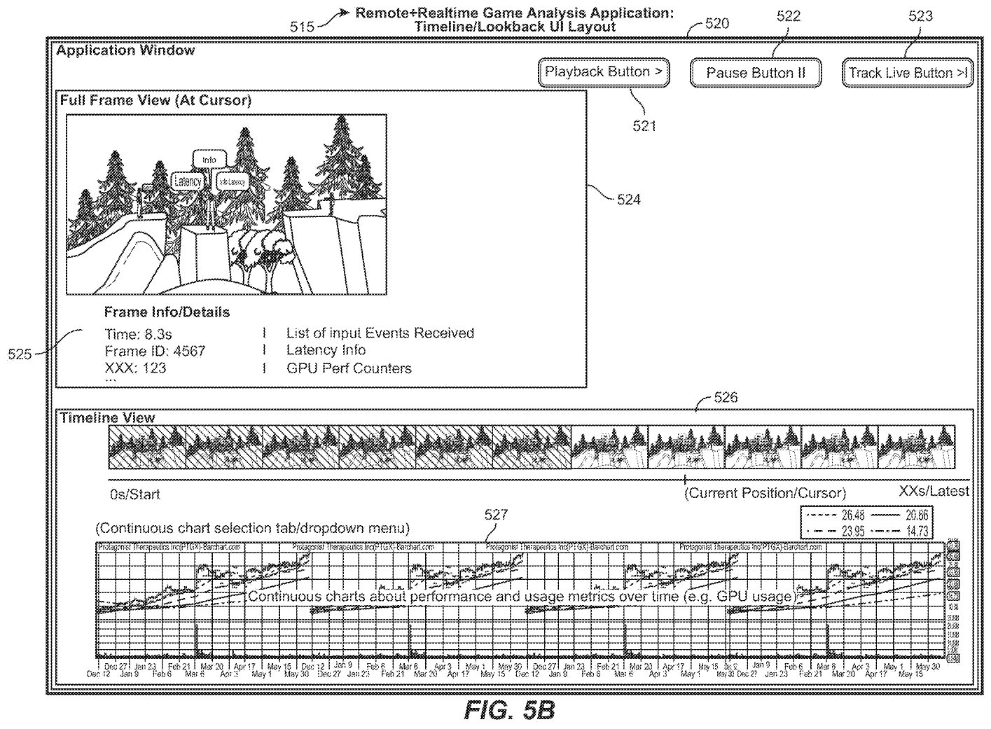

These embodiments are further illustrated with regard to FIGS. 4A, 4B and 5. FIGS. 4A and 4B illustrate embodiments of a telemetry pipeline 400 in which telemetry events are shared between a video game process 402 and a gaming operating system 413, as managed and controlled by a telemetry service 422. The telemetry service 422 of FIG. 4B includes a telemetry dispatcher daemon that receives information from the gaming operating system 413 and performs operations on the data. The gaming operating system 413 similarly includes different applications or modules that perform different functions, including communicating with a game session container 401 through a shared memory 410. The game session container 401 includes various game processes 402 and collectors 404 that gather or collect events 405 and serialize those events into specific data structures at 407. In some cases, the collectors 404 gather the events 405 according to specific parameters or settings defined in configuration information 408. This configuration information is set by a user or by the gaming operating system 413 through various control endpoints 415. The resulting configuration information (e.g., a config file 416) is stored in a data store (e.g., 409) and is passed to the video game process 402.

In some cases, the serialized data structures created at 407 are added to an event pool 406 and are aggregated or batched prior to transmission to different event consumers. Additionally or alternatively, in some examples, the serialized data structures created at 407 are sent to a lockless queue 412 in shared memory 410. The lockless queue provides low latency transmission between the game process 402 and the gaming operating system 413. The lockless queue 412, in conjunction with the lockless ring allocator 411, provides real-time data transfer, as well as reduced CPU usage by avoiding copying data from user space to kernel space and back. Such functionality is not provided by traditional telemetry systems. The gaming operating system 413 further includes a telemetry shipper daemon 414 that controls transmission between internal modules and provides or facilitates the transportation of configuration information. In some cases, the configuration information may control one or more of the processes in the gaming operating system 413, including adding session context 418 (including context regarding the originating process), compressing the event data 419, sending information to queues 420, retrying transmission when necessary 421, batching events in a batch pool 430, and dequeuing and releasing the batch at 417.

The server 428 of FIG. 4B includes a telemetry service 422 that has a telemetry dispatcher daemon 429 that is configured to receive events or batches of events and then deserialize and/or create individual standalone events at 425. These events are sent to various sink modules where different modules filter, queue, and send events to consumer services 427, short-term or long-term storage, to subscribers, or to streaming data clients. As used herein, a “sink” or “sink module” refers to a data storage location to which events are synchronized. In some cases, the sink module will filter which events are stored and which are not. Those events that are to be synchronized are placed in a sink queue 426 and then provided to an event consumer. At least in some cases, the sinks are controlled by or are operated according to parameters established in a configuration database 423. In this manner, video game events are monitored, serialized, stored, and provided to event consumers with low latency and with a high level of reliability.

FIG. 5A illustrates an embodiment in which a telemetry pipeline 500 is implemented to transfer video game events between different embodiments and modules within a system. In some embodiments, a human player 501 or a plurality of human players is playing a video game, each within their own video game session. At 505, a test is run on a game or gaming session on a gaming appliance. At 506, actual game usage and performance counters are collected using the telemetry system described herein. At least in some cases, the game usage information includes GPU device usage, GPU energy consumption, or other usage statistics. At 507, the systems herein inform game developers or other entities of various information using visualization tools and live or real time usage dashboards.

At 508, a human player (or in some cases, other automation friendly modules or elements including frame sequence captures 502, a built-in demo mode 503 within the video game, and bot or artificial intelligence (AI) or input events 504) may run a game or gaming session on a gaming appliance. During the gaming session, the system (at 509) collects actual usage information and performance counters using the telemetry system described herein. At 510, the system informs and/or trains appliance capacity steering system models and network performance models. At 511, the system enforces or polices actual GPU usage or planned session usage with associated hardware.

In some cases, a machine learning model (e.g., 118 of FIG. 1) is trained to perform tasks performed by the telemetry pipeline 500. These tasks for which a machine learning model is trained include projecting communication metrics (e.g., based on specified performance counters), planning GPU capacity, or projecting GPU usage. Thus, across a plurality of video game servers that include GPUs, ML models may be trained to project how much GPU capacity will be available at a given time or how GPU resources are projected to be used. These projections are then implemented by the telemetry pipeline to optimize GPU resources and optimize the transfer of telemetry messages during the graphics generation process.

In some embodiments, a user interface tool 515 is provided to monitor frame-based live performance of games. The user interface tool 515 includes an application window 520 showing a timeline or lookback UI layout for remote or real time game analysis. This tool (with combined user interface) is built on the extended telemetry pipeline and system described herein. The application window 520 includes a playback button 521, a pause button 522, and a track live button 523. The full frame view 524 allows users to view video frame information or other details 525 for each video frame or sequence of frames. The frame details may include a frame ID, a list of input events received, latency information, GPU performance information, sequence duration, and other information. The tool also provides a timeline view 526 that shows a sequence of video frames changing over time.

The tool further provides a continuous chart selection tab or dropdown menu 527 that allows users to view continuous charts about performance and usage metrics over time. Thus, as shown in the timeline view 526, a user can select a frame with a cursor and that frame's associated information in the full frame view 524 in the application window 520. Performance and usage metrics are shown in the charts of the dropdown menu 527. In this manner, a user may view information about substantially any video frame or any sequence in a game to determine how the underlying system was operating and why computing resources were behaving as reported.

In addition to the computer-implemented method described above, a corresponding system is also described. The system includes at least one physical processor, and physical memory comprising computer-executable instructions that, when executed by the physical processor, cause the physical processor to: access one or more telemetry events generated by one or more hardware components of a graphics processing unit (GPU) as part of a graphics generation process, serialize the accessed telemetry events into one or more specified data structures, store the specified data structures associated with the serialized events in a shared memory location that is shared by a plurality of concurrently running media application sessions, and provide, in real time, a reference to the stored data structures associated with the serialized events in the shared memory location to one or more event consumers.

Still further, a non-transitory computer-readable medium is provided that includes one or more computer-executable instructions that, when executed by at least one processor of a computing device, cause the computing device to: access one or more telemetry events generated by one or more hardware components of a graphics processing unit (GPU) as part of a graphics generation process, serialize the accessed telemetry events into one or more specified data structures, store the specified data structures associated with the serialized events in a shared memory location that is shared by a plurality of concurrently running media application sessions, and provide, in real time, a reference to the stored data structures associated with the serialized events in the shared memory location to one or more event consumers.

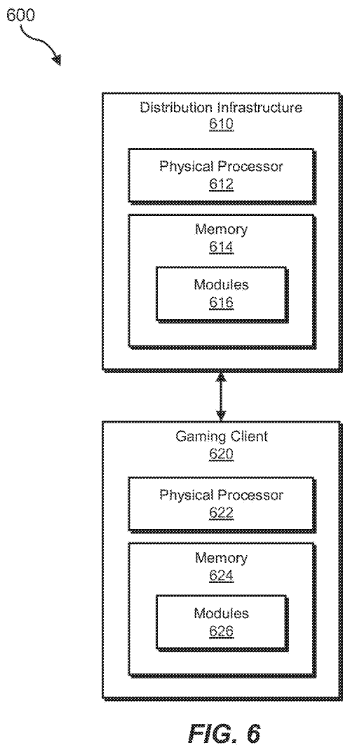

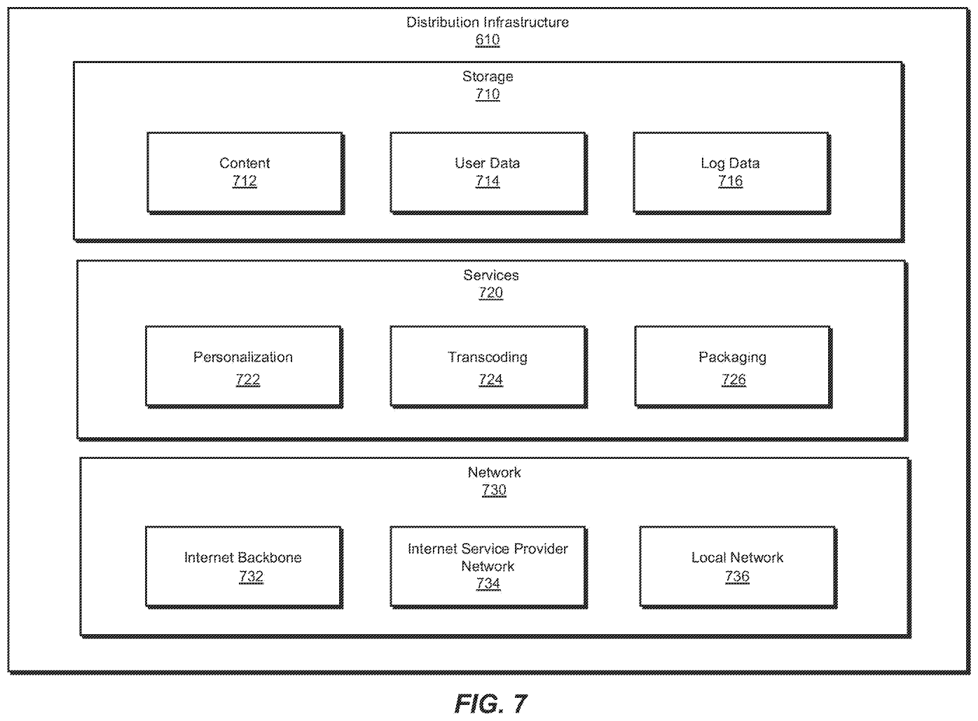

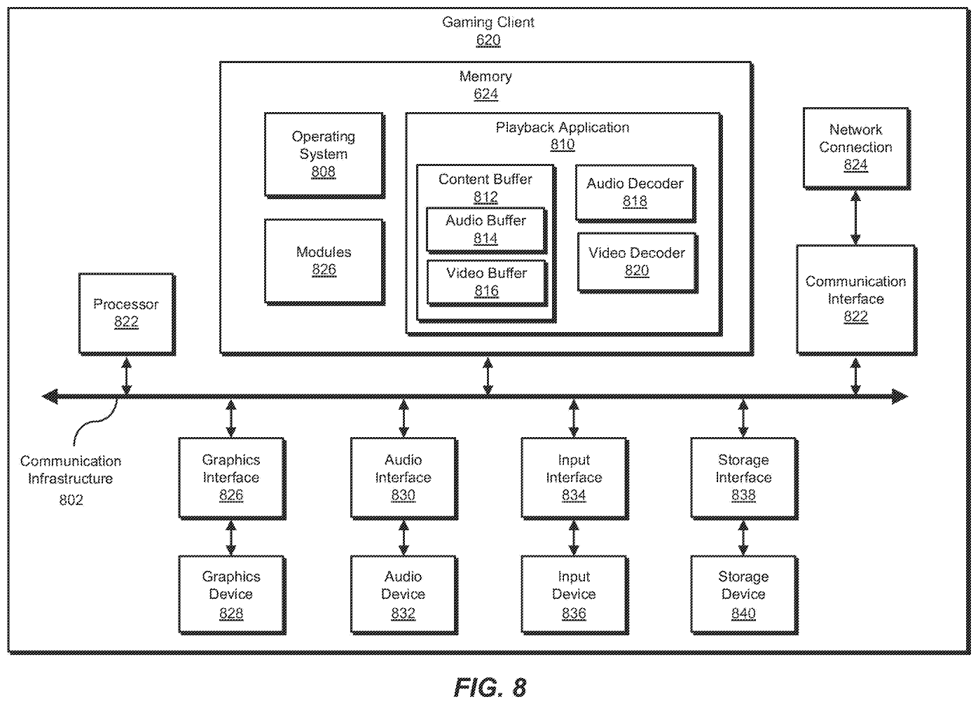

FIGS. 6-8 illustrate cloud gaming systems, infrastructure, and clients that may be implemented with the embodiments herein. For example, the following will provide, with reference to FIG. 6, detailed descriptions of exemplary ecosystems in which content is provisioned to end nodes and in which requests for content are steered to specific end nodes. The discussion corresponding to FIGS. 7 and 8 presents an overview of an exemplary distribution infrastructure and an exemplary content player used during playback sessions, respectively.

FIG. 6 is a block diagram of a content distribution ecosystem 600 that includes a distribution infrastructure 610 in communication with a gaming client 620, content player, or other software application designed to present rendered graphics to a user. In some embodiments, distribution infrastructure 610 is configured to encode data at a specific data rate and to transfer the encoded data to gaming client 620. Gaming client 620 is configured to receive the encoded data via distribution infrastructure 610 and to decode the data for playback to a user. The data provided by distribution infrastructure 610 includes, for example, audio, video, text, images, animations, interactive content, haptic data, virtual or augmented reality data, location data, gaming data, or any other type of data that is provided via streaming.

Distribution infrastructure 610 generally represents any services, hardware, software, or other infrastructure components configured to deliver content to end users. For example, distribution infrastructure 610 includes content aggregation systems, media transcoding and packaging services, network components, and/or a variety of other types of hardware and software. In some cases, distribution infrastructure 610 is implemented as a highly complex distribution system, a single media server or device, or anything in between. In some examples, regardless of size or complexity, distribution infrastructure 610 includes at least one physical processor 612 and at least one memory device 614. One or more modules 616 are stored or loaded into memory 614 to enable adaptive streaming, as discussed herein.

Gaming client 620 generally represents any type or form of device or system capable of playing audio, video, or other gaming content that has been provided over distribution infrastructure 610. Examples of gaming client 620 include, without limitation, mobile phones, tablets, laptop computers, desktop computers, televisions, set-top boxes, digital media players, virtual reality headsets, augmented reality glasses, and/or any other type or form of device capable of rendering digital content. As with distribution infrastructure 610, gaming client 620 includes a physical processor 622, memory 624, and one or more modules 626. Some or all of the adaptive streaming processes described herein is performed or enabled by modules 626, and in some examples, modules 616 of distribution infrastructure 610 coordinate with modules 626 of gaming client 620 to provide adaptive streaming of multimedia content.

In certain embodiments, one or more of modules 616 and/or 626 in FIG. 6 represent one or more software applications or programs that, when executed by a computing device, cause the computing device to perform one or more tasks. For example, and as will be described in greater detail below, one or more of modules 616 and 626 represent modules stored and configured to run on one or more general-purpose computing devices. One or more of modules 616 and 626 in FIG. 6 also represent all or portions of one or more special-purpose computers configured to perform one or more tasks.

In addition, one or more of the modules, processes, algorithms, or steps described herein transform data, physical devices, and/or representations of physical devices from one form to another. For example, one or more of the modules recited herein receive audio data to be encoded, transform the audio data by encoding it, output a result of the encoding for use in an adaptive audio bit-rate system, transmit the result of the transformation to a content player, and render the transformed data to an end user for consumption. Additionally or alternatively, one or more of the modules recited herein transform a processor, volatile memory, non-volatile memory, and/or any other portion of a physical computing device from one form to another by executing on the computing device, storing data on the computing device, and/or otherwise interacting with the computing device.

Physical processors 612 and 622 generally represent any type or form of hardware-implemented processing unit capable of interpreting and/or executing computer-readable instructions. In one example, physical processors 612 and 622 access and/or modify one or more of modules 616 and 626, respectively. Additionally or alternatively, physical processors 612 and 622 execute one or more of modules 616 and 626 to facilitate adaptive streaming of multimedia content. Examples of physical processors 612 and 622 include, without limitation, microprocessors, microcontrollers, central processing units (CPUs), field-programmable gate arrays (FPGAs) that implement softcore processors, application-specific integrated circuits (ASICs), portions of one or more of the same, variations or combinations of one or more of the same, and/or any other suitable physical processor.

Memory 614 and 624 generally represent any type or form of volatile or non-volatile storage device or medium capable of storing data and/or computer-readable instructions. In one example, memory 614 and/or 624 stores, loads, and/or maintains one or more of modules 616 and 626. Examples of memory 614 and/or 624 include, without limitation, random access memory (RAM), read only memory (ROM), flash memory, hard disk drives (HDDs), solid-state drives (SSDs), optical disk drives, caches, variations or combinations of one or more of the same, and/or any other suitable memory device or system.

FIG. 7 is a block diagram of exemplary components of content distribution infrastructure 610 according to certain embodiments. Distribution infrastructure 610 includes storage 710, services 720, and a network 730. Storage 710 generally represents any device, set of devices, and/or systems capable of storing content for delivery to end users. Storage 710 includes a central repository with devices capable of storing terabytes or petabytes of data and/or includes distributed storage systems (e.g., appliances that mirror or cache content at Internet interconnect locations to provide faster access to the mirrored content within certain regions). Storage 710 is also configured in any other suitable manner.

As shown, storage 710 may store a variety of different items including content 712, user data 714, and/or log data 716. Content 712 includes television shows, movies, video games, user-generated content, and/or any other suitable type or form of content. User data 714 includes personally identifiable information (PII), payment information, preference settings, language and accessibility settings, and/or any other information associated with a particular user or content player. Log data 716 includes viewing history information, network throughput information, and/or any other metrics associated with a user's connection to or interactions with distribution infrastructure 610.

Services 720 includes personalization services 722, transcoding services 724, and/or packaging services 726. Personalization services 722 personalize recommendations, content streams, and/or other aspects of a user's experience with distribution infrastructure 610. Encoding services 724 compress media at different bitrates which, as described in greater detail below, enable real-time switching between different encodings. Packaging services 726 package encoded video before deploying it to a delivery network, such as network 730, for streaming.

Network 730 generally represents any medium or architecture capable of facilitating communication or data transfer. Network 730 facilitates communication or data transfer using wireless and/or wired connections. Examples of network 730 include, without limitation, an intranet, a wide area network (WAN), a local area network (LAN), a personal area network (PAN), the Internet, power line communications (PLC), a cellular network (e.g., a global system for mobile communications (GSM) network), portions of one or more of the same, variations or combinations of one or more of the same, and/or any other suitable network. For example, as shown in FIG. 7, network 730 includes an Internet backbone 732, an internet service provider 734, and/or a local network 736. As discussed in greater detail below, bandwidth limitations and bottlenecks within one or more of these network segments triggers video and/or audio bit rate adjustments.

FIG. 8 is a block diagram of an exemplary implementation of gaming client 620 of FIG. 6. Gaming client 620 generally represents any type or form of computing device capable of reading computer-executable instructions. Gaming client 620 includes, without limitation, laptops, tablets, desktops, servers, cellular phones, multimedia players, embedded systems, wearable devices (e.g., smart watches, smart glasses, etc.), smart vehicles, gaming consoles, internet-of-things (IoT) devices such as smart appliances, variations or combinations of one or more of the same, and/or any other suitable computing device.

As shown in FIG. 8, in addition to processor 622 and memory 624, gaming client 620 includes a communication infrastructure 802 and a communication interface 822 coupled to a network connection 824. Gaming client 620 also includes a graphics interface 826 coupled to a graphics device 828, an input interface 834 coupled to an input device 836, and a storage interface 838 coupled to a storage device 840.

Communication infrastructure 802 generally represents any type or form of infrastructure capable of facilitating communication between one or more components of a computing device. Examples of communication infrastructure 802 include, without limitation, any type or form of communication bus (e.g., a peripheral component interconnect (PCI) bus, PCI Express (PCIe) bus, a memory bus, a frontside bus, an integrated drive electronics (IDE) bus, a control or register bus, a host bus, etc.).

As noted, memory 624 generally represents any type or form of volatile or non-volatile storage device or medium capable of storing data and/or other computer-readable instructions. In some examples, memory 624 stores and/or loads an operating system 808 for execution by processor 622. In one example, operating system 808 includes and/or represents software that manages computer hardware and software resources and/or provides common services to computer programs and/or applications on gaming client 620.

Operating system 808 performs various system management functions, such as managing hardware components (e.g., graphics interface 826, audio interface 830, input interface 834, and/or storage interface 838). Operating system 808 also provides process and memory management models for playback application 810. The modules of playback application 810 includes, for example, a content buffer 812, an audio decoder 818, and a video decoder 820.

Playback application 810 is configured to retrieve digital content via communication interface 822 and to play the digital content through graphics interface 826. Graphics interface 826 is configured to transmit a rendered video signal to graphics device 828. In normal operation, playback application 810 receives a request from a user to play a specific title or specific content. Playback application 810 then identifies one or more encoded video and audio streams associated with the requested title. After playback application 810 has located the encoded streams associated with the requested title, playback application 810 downloads sequence header indices associated with each encoded stream associated with the requested title from distribution infrastructure 610. A sequence header index associated with encoded content includes information related to the encoded sequence of data included in the encoded content.

In one embodiment, playback application 810 begins downloading the content associated with the requested title by downloading sequence data encoded to the lowest audio and/or video playback bitrates to minimize startup time for playback. The requested digital content file is then downloaded into content buffer 812, which is configured to serve as a first-in, first-out queue. In one embodiment, each unit of downloaded data includes a unit of video data or a unit of audio data. As units of video data associated with the requested digital content file are downloaded to the gaming client 620, the units of video data are pushed into the content buffer 812. Similarly, as units of audio data associated with the requested digital content file are downloaded to the gaming client 620, the units of audio data are pushed into the content buffer 812. In one embodiment, the units of video data are stored in video buffer 816 within content buffer 812 and the units of audio data are stored in audio buffer 814 of content buffer 812.

A video decoder 820 reads units of video data from video buffer 816 and outputs the units of video data in a sequence of video frames corresponding in duration to the fixed span of playback time. Reading a unit of video data from video buffer 816 effectively de-queues the unit of video data from video buffer 816. The sequence of video frames is then rendered by graphics interface 826 and transmitted to graphics device 828 to be displayed to a user.

An audio decoder 818 reads units of audio data from audio buffer 814 and outputs the units of audio data as a sequence of audio samples, generally synchronized in time with a sequence of decoded video frames. In one embodiment, the sequence of audio samples is transmitted to audio interface 830, which converts the sequence of audio samples into an electrical audio signal. The electrical audio signal is then transmitted to a speaker of audio device 832, which, in response, generates an acoustic output.

In situations where the bandwidth of distribution infrastructure 610 is limited and/or variable, playback application 810 downloads and buffers consecutive portions of video data and/or audio data from video encodings with different bit rates based on a variety of factors (e.g., scene complexity, audio complexity, network bandwidth, device capabilities, etc.). In some embodiments, video playback quality is prioritized over audio playback quality. Audio playback and video playback quality are also balanced with each other, and in some embodiments audio playback quality is prioritized over video playback quality.

Graphics interface 826 is configured to generate frames of video data and transmit the frames of video data to graphics device 828. In one embodiment, graphics interface 826 is included as part of an integrated circuit, along with processor 622. Alternatively, graphics interface 826 is configured as a hardware accelerator that is distinct from (i.e., is not integrated within) a chipset that includes processor 622.

Graphics interface 826 generally represents any type or form of device configured to forward images for display on graphics device 828. For example, graphics device 828 is fabricated using liquid crystal display (LCD) technology, cathode-ray technology, and light-emitting diode (LED) display technology (either organic or inorganic). In some embodiments, graphics device 828 also includes a virtual reality display and/or an augmented reality display. Graphics device 828 includes any technically feasible means for generating an image for display. In other words, graphics device 828 generally represents any type or form of device capable of visually displaying information forwarded by graphics interface 826.

As illustrated in FIG. 8, gaming client 620 also includes at least one input device 836 coupled to communication infrastructure 802 via input interface 834. Input device 836 generally represents any type or form of computing device capable of providing input, either computer or human generated, to gaming client 620. Examples of input device 836 include, without limitation, a keyboard, a pointing device, a speech recognition device, a touch screen, a wearable device (e.g., a glove, a watch, etc.), a controller, variations or combinations of one or more of the same, and/or any other type or form of electronic input mechanism.

Gaming client 620 also includes a storage device 840 coupled to communication infrastructure 802 via a storage interface 838. Storage device 840 generally represents any type or form of storage device or medium capable of storing data and/or other computer-readable instructions. For example, storage device 840 may be a magnetic disk drive, a solid-state drive, an optical disk drive, a flash drive, or the like. Storage interface 838 generally represents any type or form of interface or device for transferring data between storage device 840 and other components of gaming client 620.

Many other devices or subsystems are included in or connected to gaming client 620. Conversely, one or more of the components and devices illustrated in FIG. 8 need not be present to practice the embodiments described and/or illustrated herein. The devices and subsystems referenced above are also interconnected in different ways from that shown in FIG. 8. Gaming client 620 is also employed in any number of software, firmware, and/or hardware configurations. For example, one or more of the example embodiments disclosed herein are encoded as a computer program (also referred to as computer software, software applications, computer-readable instructions, or computer control logic) on a computer-readable medium. The term “computer-readable medium,” as used herein, refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, etc.), optical-storage media (e.g., Compact Disks (CDs), Digital Video Disks (DVDs), and BLU-RAY disks), electronic-storage media (e.g., solid-state drives and flash media), and other digital storage systems.

A computer-readable medium containing a computer program is loaded into gaming client 620. All or a portion of the computer program stored on the computer-readable medium is then stored in memory 624 and/or storage device 840. When executed by processor 622, a computer program loaded into memory 624 causes processor 622 to perform and/or be a means for performing the functions of one or more of the example embodiments described and/or illustrated herein. Additionally or alternatively, one or more of the example embodiments described and/or illustrated herein are implemented in firmware and/or hardware. For example, gaming client 620 is configured as an Application Specific Integrated Circuit (ASIC) adapted to implement one or more of the example embodiments disclosed herein

### Example Embodiments

Example 1: A computer-implemented method comprising: accessing one or more telemetry events generated by one or more hardware components of a graphics processing unit (GPU) as part of a graphics generation process, serializing the accessed telemetry events into one or more specified data structures, storing the specified data structures associated with the serialized events in a shared memory location that is shared by a plurality of concurrently running media application sessions, and providing, in real time, a reference to the stored data structures associated with the serialized events in the shared memory location to one or more event consumers.

Example 2: The computer-implemented method of Example 1, wherein the plurality of concurrently running media sessions comprise video game sessions.

Example 3: The computer-implemented method of Example 1 or Example 2, wherein at least one of the event consumers comprises a video game operating system.

Example 4: The computer-implemented method of any of Examples 1-3, wherein the telemetry events include video game session information including at least one of user information, client device information, quality of service (QOS) information, or video game session information.

Example 5: The computer-implemented method of any of Examples 1-4, further comprising monitoring the references provided in real time to the shared memory location to initialize one or more processes related to the media sessions.

Example 6: The computer-implemented method of any of Examples 1-5, wherein the one or more initialized processes comprise a process to transition one or more media sessions to an alternate host computing system.

Example 7: The computer-implemented method of any of Examples 1-6, wherein the one or more initialized processes comprise a process to determine whether malicious activity is occurring on at least one of the media sessions.

Example 8: The computer-implemented method of any of Examples 1-7, further comprising: aggregating a plurality of events from multiple different media application sessions and routing the aggregated plurality of events to at least one of the one or more event consumers.

Example 9: The computer-implemented method of any of Examples 1-8, wherein the reference to the stored data structures associated with the serialized events is specified in a protocol buffer.

Example 10: The computer-implemented method of any of Examples 1-9, wherein a plurality of references to stored data structures associated with the serialized events are co-located in an event pool in the shared memory location.

Example 11: The computer-implemented method of any of Examples 1-10, further comprising monitoring the event pool for changes in at least one of the events.

Example 12: The computer-implemented method of any of Examples 1-11, further comprising tracking which serialized events are dropped during communication.

Example 13: A system comprising: at least one physical processor, and physical memory comprising computer-executable instructions that, when executed by the physical processor, cause the physical processor to: access one or more telemetry events generated by one or more hardware components of a graphics processing unit (GPU) as part of a graphics generation process, serialize the accessed telemetry events into one or more specified data structures, store the specified data structures associated with the serialized events in a shared memory location that is shared by a plurality of concurrently running media application sessions, and provide, in real time, a reference to the stored data structures associated with the serialized events in the shared memory location to one or more event consumers.

Example 14: The system of Example 13, wherein the reference to the stored data structures associated with the serialized events in the shared memory location is provided to one or more event consumers in batches.

Example 15: The system of Example 13 or Example 14, further comprising adding one or more portions of contextual information to at least one of the batches provided to event consumers.

Example 16: The system of any of Examples 13-15, wherein one or more batching characteristics associated with the batches are configurable to define the batches in a customizable manner.

Example 17: The system of any of Examples 13-16, further comprising training a machine learning model to perform at least one of: projecting communication metrics, planning GPU capacity, or projecting GPU usage.

Example 18: The system of any of Examples 13-17, further comprising monitoring the references provided in real time to the shared memory location to initialize one or more processes related to the media sessions.

Example 19: The system of any of Examples 13-18, wherein the one or more initialized processes comprise a process to determine whether malicious activity is occurring on at least one of the media sessions.

Example 20: A non-transitory computer-readable medium comprising one or more computer-executable instructions that, when executed by at least one processor of a computing device, cause the computing device to: access one or more telemetry events generated by one or more hardware components of a graphics processing unit (GPU) as part of a graphics generation process, serialize the accessed telemetry events into one or more specified data structures, store the specified data structures associated with the serialized events in a shared memory location that is shared by a plurality of concurrently running media application sessions, and provide, in real time, a reference to the stored data structures associated with the serialized events in the shared memory location to one or more event consumers.

As detailed above, the computing devices and systems described and/or illustrated herein broadly represent any type or form of computing device or system capable of executing computer-readable instructions, such as those contained within the modules described herein. In their most basic configuration, these computing device(s) may each include at least one memory device and at least one physical processor.

In some examples, the term “memory device” generally refers to any type or form of volatile or non-volatile storage device or medium capable of storing data and/or computer-readable instructions. In one example, a memory device may store, load, and/or maintain one or more of the modules described herein. Examples of memory devices include, without limitation, Random Access Memory (RAM), Read Only Memory (ROM), flash memory, Hard Disk Drives (HDDs), Solid-State Drives (SSDs), optical disk drives, caches, variations or combinations of one or more of the same, or any other suitable storage memory.

In some examples, the term “physical processor” generally refers to any type or form of hardware-implemented processing unit capable of interpreting and/or executing computer-readable instructions. In one example, a physical processor may access and/or modify one or more modules stored in the above-described memory device. Examples of physical processors include, without limitation, microprocessors, microcontrollers, Central Processing Units (CPUs), Field-Programmable Gate Arrays (FPGAs) that implement softcore processors, Application-Specific Integrated Circuits (ASICs), portions of one or more of the same, variations or combinations of one or more of the same, or any other suitable physical processor.

Although illustrated as separate elements, the modules described and/or illustrated herein may represent portions of a single module or application. In addition, in certain embodiments one or more of these modules may represent one or more software applications or programs that, when executed by a computing device, may cause the computing device to perform one or more tasks. For example, one or more of the modules described and/or illustrated herein may represent modules stored and configured to run on one or more of the computing devices or systems described and/or illustrated herein. One or more of these modules may also represent all or portions of one or more special-purpose computers configured to perform one or more tasks.

In addition, one or more of the modules described herein may transform data, physical devices, and/or representations of physical devices from one form to another. Additionally or alternatively, one or more of the modules recited herein may transform a processor, volatile memory, non-volatile memory, and/or any other portion of a physical computing device from one form to another by executing on the computing device, storing data on the computing device, and/or otherwise interacting with the computing device.

In some embodiments, the term “computer-readable medium” generally refers to any form of device, carrier, or medium capable of storing or carrying computer-readable instructions. Examples of computer-readable media include, without limitation, transmission-type media, such as carrier waves, and non-transitory-type media, such as magnetic-storage media (e.g., hard disk drives, tape drives, and floppy disks), optical-storage media (e.g., Compact Disks (CDs), Digital Video Disks (DVDs), and BLU-RAY disks), electronic-storage media (e.g., solid-state drives and flash media), and other distribution systems.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various exemplary methods described and/or illustrated herein may also omit one or more of the steps described or illustrated herein or include additional steps in addition to those disclosed.

The preceding description has been provided to enable others skilled in the art to best utilize various aspects of the exemplary embodiments disclosed herein. This exemplary description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to the appended claims and their equivalents in determining the scope of the present disclosure.

Unless otherwise noted, the terms “connected to” and “coupled to” (and their derivatives), as used in the specification and claims, are to be construed as permitting both direct and indirect (i.e., via other elements or components) connection. In addition, the terms “a” or “an,” as used in the specification and claims, are to be construed as meaning “at least one of.” Finally, for ease of use, the terms “including” and “having” (and their derivatives), as used in the specification and claims, are interchangeable with and have the same meaning as the word “comprising.”

What is claimed is:

1. A computer-implemented method comprising:
accessing one or more telemetry events generated by one or more hardware components of a graphics processing unit (GPU) as part of a graphics generation process;
serializing the accessed telemetry events into one or more specified data structures;
storing the specified data structures associated with the serialized events in a shared memory location that is shared by a plurality of concurrently running media application sessions; and
providing, in real time, a reference to the stored data structures associated with the serialized events in the shared memory location to one or more event consumers.

2. The computer-implemented method of claim 1, wherein the plurality of concurrently running media sessions comprise video game sessions.

3. The computer-implemented method of claim 2, wherein at least one of the event consumers comprises a video game operating system.

4. The computer-implemented method of claim 2, wherein the telemetry events include video game session information including at least one of user information, client device information, quality of service (QOS) information, or video game session information.

5. The computer-implemented method of claim 1, further comprising monitoring the references provided in real time to the shared memory location to initialize one or more processes related to the media sessions.

6. The computer-implemented method of claim 5, wherein the one or more initialized processes comprise a process to transition one or more media sessions to an alternate host computing system.

7. The computer-implemented method of claim 5, wherein the one or more initialized processes comprise a process to determine whether malicious activity is occurring on at least one of the media sessions.

8. The computer-implemented method of claim 1, further comprising:
aggregating a plurality of events from multiple different media application sessions; and
routing the aggregated plurality of events to at least one of the one or more event consumers.

9. The computer-implemented method of claim 1, wherein the reference to the stored data structures associated with the serialized events is specified in a protocol buffer.

10. The computer-implemented method of claim 1, wherein a plurality of references to stored data structures associated with the serialized events are co-located in an event pool in the shared memory location.

11. The computer-implemented method of claim 10, further comprising monitoring the event pool for changes in at least one of the events.

12. The computer-implemented method of claim 1, further comprising tracking which serialized events are dropped during communication.

13. A system comprising:
at least one physical processor; and
physical memory comprising computer-executable instructions that, when executed by the physical processor, cause the physical processor to:
access one or more telemetry events generated by one or more hardware components of a graphics processing unit (GPU) as part of a graphics generation process;
serialize the accessed telemetry events into one or more specified data structures;
store the specified data structures associated with the serialized events in a shared memory location that is shared by a plurality of concurrently running media application sessions; and
provide, in real time, a reference to the stored data structures associated with the serialized events in the shared memory location to one or more event consumers.

14. The system of claim 13, wherein the reference to the stored data structures associated with the serialized events in the shared memory location is provided to one or more event consumers in batches.

15. The system of claim 14, further comprising adding one or more portions of contextual information to at least one of the batches provided to event consumers.

16. The system of claim 14, wherein one or more batching characteristics associated with the batches are configurable to define the batches in a customizable manner.

17. The system of claim 13, further comprising training a machine learning model to perform at least one of: projecting communication metrics, planning GPU capacity, or projecting GPU usage.

18. The system of claim 13, further comprising monitoring the references provided in real time to the shared memory location to initialize one or more processes related to the media sessions.

19. The system of claim 18, wherein the one or more initialized processes comprise a process to determine whether malicious activity is occurring on at least one of the media sessions.

20. A non-transitory computer-readable medium comprising one or more computer-executable instructions that, when executed by at least one processor of a computing device, cause the computing device to:
access one or more telemetry events generated by one or more hardware components of a graphics processing unit (GPU) as part of a graphics generation process;
serialize the accessed telemetry events into one or more specified data structures;
store the specified data structures associated with the serialized events in a shared memory location that is shared by a plurality of concurrently running media application sessions; and
provide, in real time, a reference to the stored data structures associated with the serialized events in the shared memory location to one or more event consumers.
